(19) United States
(12) Patent Application Publication
(10) Pub. No.: US 2004/0125049 A1
(43) Pub. Date: Jul. 1, 2004

(54) Method and apparatus for grayscale enhancement of a display device

(76) Inventors: Sebastien Weitbruch, Monchweller (DE); Cedric Thebault, Villingen-Schwenningen (DE); Carlos Correa, Villingen-Schwenningen (DE)

Correspondence Address: JOSEPH S. TRIPOLI, THOMSON LICENSING INC., 2 INDEPENDENCE WAY, Suite 200, P.O. BOX 5312, PRINCETON, NJ, 08543-5312, US

(21) Appl. No.: 10/625,117

(22) Filed: Jul. 22, 2003

(30) Foreign Application Priority Data
Jul. 30, 2002 (EP) 02291925.2

(51) Int. Cl. G09G 3/28

(52) U.S. Cl. 345/60

(57) ABSTRACT

A method and an apparatus for displaying pictures with an improved grey scale portrayal shall be provided. Therefore, the quantization steps of the digitized signals for a plasma panel display have to be reduced. To achieve such reduction of quantization steps of the light output of a cell of the plasma display panel, the energy of the addressing impulse for addressing those luminous elements which have to be activated for a complete frame period or a part of it is used. Consequently, the light output of the luminous elements can be controlled by the usual sustain impulses and additionally by the addressing impulses thus reducing the quantization steps.

The present invention relates to a method and an apparatus for grayscale enhancement of a display device. More specifically the invention is closely related to a kind of video processing for improving the picture quality of pictures which are displayed on devices like plasma display panels (PDP) and all kinds of displays based on the principle of duty cycle modulation (pulse width modulation) of light emission. Particularly, the present invention relates to an apparatus and a method for driving a display device having a plurality of luminous elements by addressing those luminous elements which have to be activated for one frame period by applying an addressing impulse having a predetermined writing voltage to each of them, and controlling the light output of each of the addressed luminous elements by applying a discrete, predetermined number of sustain impulses each having the same predetermined sustain voltage.

### BACKGROUND

A PDP utilizes a matrix array of discharge cells which can only be “ON” or “OFF”. Therefore, a PDP can be defined as a pure digital display. Also unlike a CRT or LCD in which grey levels are expressed by analog control of the light emission, a PDP controls the grey level by modulating the number of light pulses per frame (sustain pulses). The time-modulated signals will be integrated by the eye over a period corresponding to the eye time response. Since the amplitude video is portrayed by the number of light pulses, occurring at a given frequency, more amplitude means more light pulses and thus more “ON” time. This kind of modulation is also known as PWM, pulse width modulation. For image quality, greyscale portrayal is of paramount importance. On Plasma Display Panels (PDPs) greyscales are not so smooth than those encountered on analog displays like CRTs. One reason of that is the so-called gamma function. Indeed all video pictures are pre-corrected to compensate the traditional gamma curves from standard displays (e.g. CRTs). Since, the plasma display is a pure linear display and does not provide such a non-linear gamma behaviour, an artificial gamma function should be performed at the display level and in a digital form.

For computing the gamma function in a digital form usually 8 bits are used which leads to 256 quantization steps. However, if, for instance, 600 cd/m² maximal luminance is available on the PDP screen, the input video value 4 should be converted according to the gamma function γ to

$$600 \cdot {( \frac{4}{255} )}^{2} = 0.15 cd \text{/} {m}^{2}$$

which is actually not possible. Indeed, the smallest video value which can be directly displayed on a PDP is defined by the light emitted by one sustain operation (actually around 0.7 cd/m²) . Moreover, the tendency today is to improve the luminance efficacy of a plasma cell so that each sustain operation should be more luminous.

Quality problems due to the big quantization steps, appear especially in the darker regions of the picture. In dark areas the eye is more sensitive than in brighter areas. This means than even if the luminance of one sustain is quite small regarding maximal luminance obtained on PDP (from 100 cd/m² for full-white up to 600 cd/m² for peak-white) the human eye will be able to see such small steps.

In contrast to that, the quantization noise will be reduced in luminous areas.

In order to better understand this problem the case of a standard degamma function applied on 8-bit level using the following formula:

$$Out ( x , y ) = 255 \cdot {( \frac{In ( x , y )}{255} )}^{γ}$$

with γ≈2 shall be taken. The assumption is made that the PDP maximal white is based on 255 sustain impulses to simplify the exposition.

FIG. 1 illustrates such a function. In the left part of the figure the quadratic gamma function according to the above formular is drawn. The input quantizised with 8 bits is converted to an output signal also quantizised with 8 bits. The gradient at input level “0” is 0. The input level “255” is converted to the output level “255”. The output signal increases parabolically. In the right half of FIG. 1 the gamma function is zoomed for the low input levels up to the value “50”. The zoomed part shows the real function and the digital function obtained by integer values.

It can be seen that the gamma function applied on 8-bit levels generates a strong quantization effect in the dark area. For instance, all input levels below 12 are set together to 0 after the gammatization. The following Table 1 presents the details of the computation for some video levels:

TABLE 1
Digitized gamma function

| Input (8-bit) | Output (float) | Output (8-bit) |
|---|---|---|
| 0 | 0 | 0 |
| 1 | 0.003921569 | 0 |
| 2 | 0.015686275 | 0 |
| 3 | 0.035294118 | 0 |
| 4 | 0.062745098 | 0 |
| 5 | 0.098039216 | 0 |
| 6 | 0.141176471 | 0 |
| 7 | 0.192156863 | 0 |
| 8 | 0.250980392 | 0 |
| 9 | 0.317647059 | 0 |
| 10 | 0.392156863 | 0 |
| 11 | 0.474509804 | 0 |
| 12 | 0.564705882 | 1 |
| 13 | 0.662745098 | 1 |
| 14 | 0.768627451 | 1 |
| 15 | 0.882352941 | 1 |
| 16 | 1.003921569 | 1 |
| 17 | 1.133333333 | 1 |
| 18 | 1.270588235 | 1 |
| 19 | 1.415686275 | 1 |
| 20 | 1.568627451 | 2 |
| 21 | 1.729411765 | 2 |
| 22 | 1.898039216 | 2 |
| 23 | 2.074509804 | 2 |
| ... | ... | ... |
| 250 | 245.0980392 | 245 |
| 251 | 247.0627451 | 247 |
| 252 | 249.0352941 | 249 |
| 253 | 251.0156863 | 251 |
| 254 | 253.0039216 | 253 |
| 255 | 255 | 255 |

This table shows that, in the dark areas, there are less output values than input values which means that the quantization steps are increased and that a lot of information is lost. On the opposite, in high levels, there are less input than output values (e.g. no input to generate the value 246) which means that the quantization noise has been reduced.

Actually, this problem is solved by rendition of the small luminance level below one sustain on the basis of a dithering operation which uses the temporal and spatial integration of the eye to render artificial levels. Nevertheless, the visibility of this dithering is linked to the minimal step which can be made on the screen (actually one sustain operation). In the case of very luminous pictures, the eye is dazzled and not so sensitive to these levels, whereas in case of dark pictures the eye is very sensitive to low levels and will be able to see the noise created by such big steps.

It is the object of the present invention to provide a method and an apparatus for displaying pictures with an improved grey scale portrayal.

According to the present invention this object is solved by a method for driving a display device having a plurality of luminous elements including the steps of addressing those luminous elements which have to be activated for one complete frame period or a part of it, called activation cycle or sub-field, by applying an addressing impulse having a predetermined writing voltage to each of them, and controlling the light output of at least one of said addressed luminous elements on the basis of the energy of said addressing impulse.

Furthermore, according to the present invention there is provided an apparatus for driving a display device having a plurality of luminous elements with addressing means for addressing at least one of said luminous elements for one complete frame period or a part of it called activation cycle, by applying an addressing impulse having a predetermined writing voltage to each of said luminous elements, and controlling means connected to said addressing means for controlling the light output of each of said luminous elements to be addressed by applying at least one sustain impulse having a predetermined sustain voltage, wherein the light output of at least one of said luminous elements to be addressed is controllable by said controlling means also on the basis of the energy of said addressing impulse from said addressing means.

Preferably it is possible to activate one of the addressed luminous elements in a one frame period by only the energy of the addressing impulse. This enables to obtain a further step for the conversion of the first twelve input levels of the previous example, namely a so-called sub-sustain weighting at input level 7 for instance.

Similarly, one of the addressed luminous elements in one frame period may be activated by the addressing impulse and at least one sustain impulse. Consequently, the discrete steps between other output levels than “0” and “1” may be reduced too.

The activation energy of one addressing impulse should be smaller than that of one sustain impulse. A combination of such activation energies allows to reduce the quantization steps of the digital processing.

The activation of luminous elements for one frame period is usually performed by a plurality of activation cycles (sub-fields) and preferably, an erasing operation is performed to the end of each activation cycle. The erasing operation ensures that any charges generated during addressing or sustaining operations are re-combined so that the respective luminous element is completely reset. At the begin of each activation cycle a time period for addressing should be reserved. Within this activation time period all luminous elements of the display which have to be activated for a frame period or a sub-period called “sub-field” of a frame are addressed by a writing/addressing impulse. A sustain operation may optionally be performed between the addressing and the erasing operation. As to the operation of a plasma display panel and specifically as to the operations of addressing, sustaining and erasing it is referred to the international patent application WO 02/11111 which is included herein by reference.

The provision of a picture analysis of the input picture has the advantage to improve the decision of using the addressing impulses for controlling the light output of the luminous elements. Especially, if the statistical distribution of luminance shows major dark regions or the brightness of the present frame is lower than a predetermined threshold the inventive principle of using the addressing impulse for controlling the output of the luminous elements may be used. Such threshold for the peak or mean brightness of the present frame may be 10% of the maximal possible brightness.

In view of that the present invention provides a technique that enables to dispose of an operation based on simple addressing without sustain, enabling to a display a subsustain light emission of e.g. 0.14 cd/m².

The main idea behind this invention is the use of sub-fields without any sustain operation. As to the principle of sub-fields it is expressively referred to the European patent application EP-A-1 136 974. In that case, the writing operation will be directly followed by an erase operation. Then, the emitted light is defined by a standard emission of the addressing writing discharge (e.g. 0.14 cd/m²).

In other words, additional sub-fields are used for a sub-sustain weight:

This can be made in case of full-white pictures having less maximal white and disposing of more sub-fields.

This can be made in combination with a picture analysis (as described in FR 0207062 filed on Jun. 5, 2002). In that case, it can be detected that the picture contains a lot of dark information and less luminous one. Then an adapted coding using sub-sustain weight can be applied.

This can be also used with standard coding when more sub-fields are available. In the past years, the addressing speed has increased a lot (3.4 μs in 1997 up to 2 μs in 2000 . . . )

### DRAWINGS

Exemplary embodiments of the invention are illustrated in the drawings and are explained in more detail in the following description.

In the drawings:

FIG. 1 shows a standard gamma function applied on 8-bit coded signals;

FIG. 2 shows the sub-field coding concept according to the present invention;

FIG. 3 shows an inventive coding concept based on 11 standard sub-fields plus 4 single-writing sub-fields;

FIG. 4 shows the principal of low level optimized coding and standard optimized coding; and

FIG. 5 shows a block diagram of a hardware implementation of the inventive coding concept.

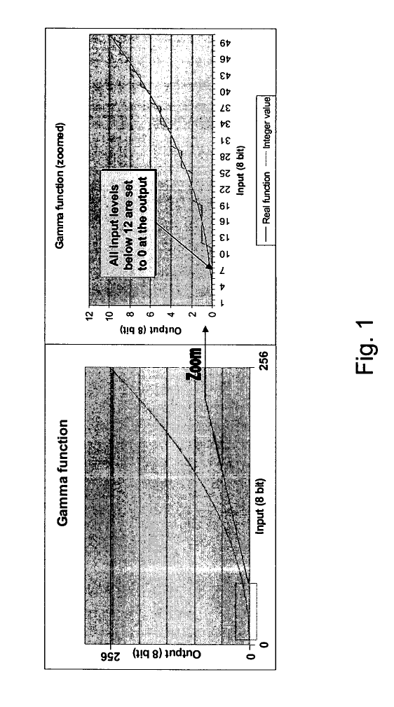

### EXEMPLARY EMBODIMENTS

The PDP addressing writing operation can be considered as a discharge appearing in the selected cell, this discharge will let a remaining charge inside the cell for a certain time (capacity effect of the plasma cells). During a following sustain operation, only the cells disposing of a charge will light. The sustain operation itself is an operation with alternating current so that at the end of the sustain cycles there is still the same charge in the cell. In order to reinitialise the cell a global erase operation following the sustain operation suppresses the charges inside the cells.

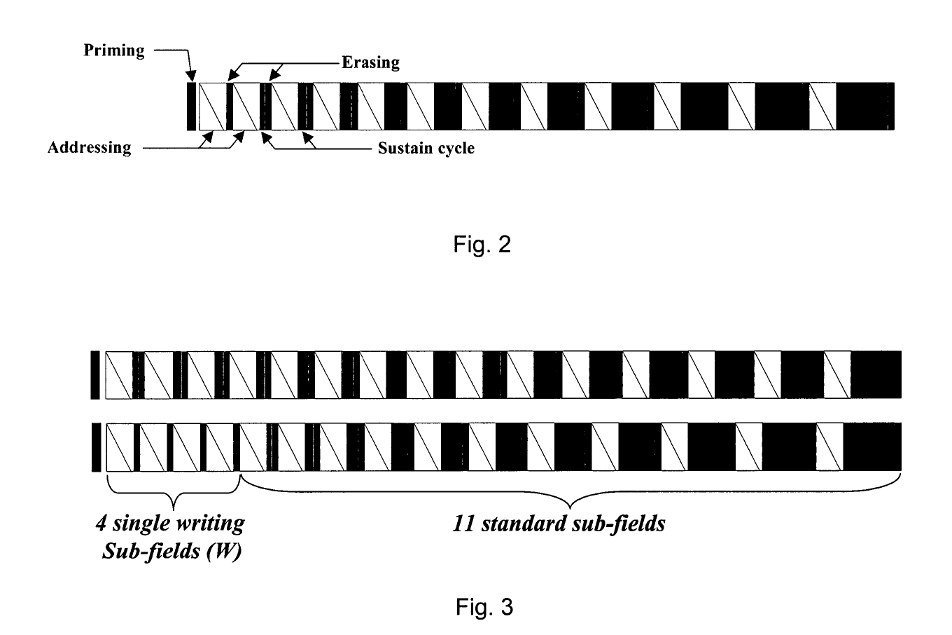

Since the addressing (writing) operation can be considered as a discharge appearing only in the selected cells, such an operation will also produce some light emission (around 0.14 cd/m²) which is much more than a single priming operation (e.g. 0.08 cd/m²). An erase operation could be then applied directly after the writing operation. In that case, since no sustain cycle has been applied, one can dispose of a sub-sustain weight having only a luminance of (0.15 cd/m²). In the example such a sub-sustain weight (0.15 cd/m²) represents around one fifth of a standard sustain operation. FIG. 2 illustrates such a new concept.

The complete frame period shown in the figure is divided into 11 standard sub-fields and one single writing sub-field as a first sub-field. A priming operation is provided at the beginning of the frame period. The first sub-field i.e. the single-writing sub-field (W), consists of an addressing block (white) and an erasing block (black). This single writing sub-field is used for sub-sustain weighting. Each of the following standard sub-fields consists of an addressing block (white) followed by a sustain block (grey) and completed by the erasing block (black). The sustain cycle or block increases in accordance with the code digit.

In that case, the previous gamma Table 1 can be upgraded to the following Table 2:

TABLE 2
Upgraded digitized gamma function

| Input (8-bit) | Output (float) | Output (8-bit) |
|---|---|---|
| 0 | 0 | 0 |
| 1 | 0.003921569 | 0 |
| 2 | 0.015686275 | 0 |
| 3 | 0.035294118 | 0 |
| 4 | 0.062745098 | 0 |
| 5 | 0.098039216 | 0 |
| 6 | 0.141176471 | 0 |
| 7 | 0.192156863 | W |
| 8 | 0.250980392 | W |
| 9 | 0.317647059 | W |
| 10 | 0.392156863 | W |
| 11 | 0.474509804 | W |
| 12 | 0.564705882 | 1 |
| 13 | 0.662745098 | 1 |
| 14 | 0.768627451 | 1 |
| 15 | 0.882352941 | 1 |
| 16 | 1.003921569 | 1 |
| 17 | 1.133333333 | 1 |
| 18 | 1.270588235 | 1+W |
| 19 | 1.415686275 | 1+W |
| 20 | 1.568627451 | 2 |
| 21 | 1.729411765 | 2 |
| 22 | 1.898039216 | 2 |
| 23 | 2.074509804 | 2 |
| ... | ... | ... |
| 250 | 245.0980392 | 245 |
| 251 | 247.0627451 | 247 |
| 252 | 249.0352941 | 249 |
| 253 | 251.0156863 | 251 |
| 254 | 253.0039216 | 253 |
| 255 | 255 | 255 |

In Table 2, a W characterizes the single writing operation. It can be seen on this table that less error is generated in the low levels since finer steps can be generated. More precision can be obtained if more single writing operations are used. Obviously, such an operation requires the same addressing time like a sustain operation and therefore it might be used only parsimoniously when enough time is available (dark pictures, full-white mode, very fast addressing speed etc.).

FIG. 3 illustrates at the bottom an example of a coding based on 11 standard sub-fields plus 4 single-writing sub-fields.

In principle the sub-field structure of this example is equal to that of FIG. 2. The first four sub-fields (activation cycles) only include an addressing block (white) and an erasing block (black). Each of the following eleven standard sub-fields includes one sustain cycle (grey). The broadness of the sustain cycles is determined by their number within the frame period. At the top of FIG. 3 there is shown a sub-field organisation with 15 standard sub-fields within the frame period. In average the sustain cycles of the 15 sub-fields at the top of FIG. 3 are a little bit smaller than the sustain cycles of the 11 standards sub-fields of the inventive frame organisation at the bottom of FIG. 3. In both cases the same maximum power of light is obtainable for the driven luminous element. However, particularly in the dark areas smaller quantization steps are possible with the embodiment of the bottom of FIG. 3.

Based on this new example, the gamma Table 1 can be updated for the first 30 levels to following Table 3:

TABLE 3
Alternatively upgraded digitized gamma function

| Input (8-bit) | Output (float) | Output (8-bit) |
|---|---|---|
| 0 | 0 | 0 |
| 1 | 0.003921569 | 0 |
| 2 | 0.015686275 | 0 |
| 3 | 0.035294118 | 0 |
| 4 | 0.062745098 | 0 |
| 5 | 0.098039216 | 0 |
| 6 | 0.141176471 | 0 |
| 7 | 0.192156863 | W |
| 8 | 0.250980392 | W |
| 9 | 0.317647059 | W |
| 10 | 0.392156863 | 2W |
| 11 | 0.474509804 | 2W |
| 12 | 0.564705882 | 3W |
| 13 | 0.662745098 | 3W |
| 14 | 0.768627451 | 4W |
| 15 | 0.882352941 | 4W |
| 16 | 1.003921569 | 1 |
| 17 | 1.133333333 | 1 |
| 18 | 1.270588235 | 1+W |
| 19 | 1.415686275 | 1+2W |
| 20 | 1.568627451 | 1+3W |
| 21 | 1.729411765 | 1+4W |
| 22 | 1.898039216 | 2 |
| 23 | 2.074509804 | 2 |
| 24 | 2.258823529 | 2+W |
| 25 | 2.450980392 | 2+2W |
| 26 | 2.650980392 | 2+3W |
| 27 | 2.858823529 | 2+4W |
| 28 | 3.074509804 | 3 |
| 29 | 3.298039216 | 3+W |
| 30 | 3.529411765 | 3+2W |

In that last example, the steps in dark areas are very small and no more noise (dithering or quantization) can be seen.

In the case of full-white picture, which will be displayed with less, sustain power (e.g. 150), then a lot of time is available for addressing operation and the use of single-writing operation can be done without extra cost in terms of timing. The same false contour behaviour can be obtained with a better greyscale portrayal.

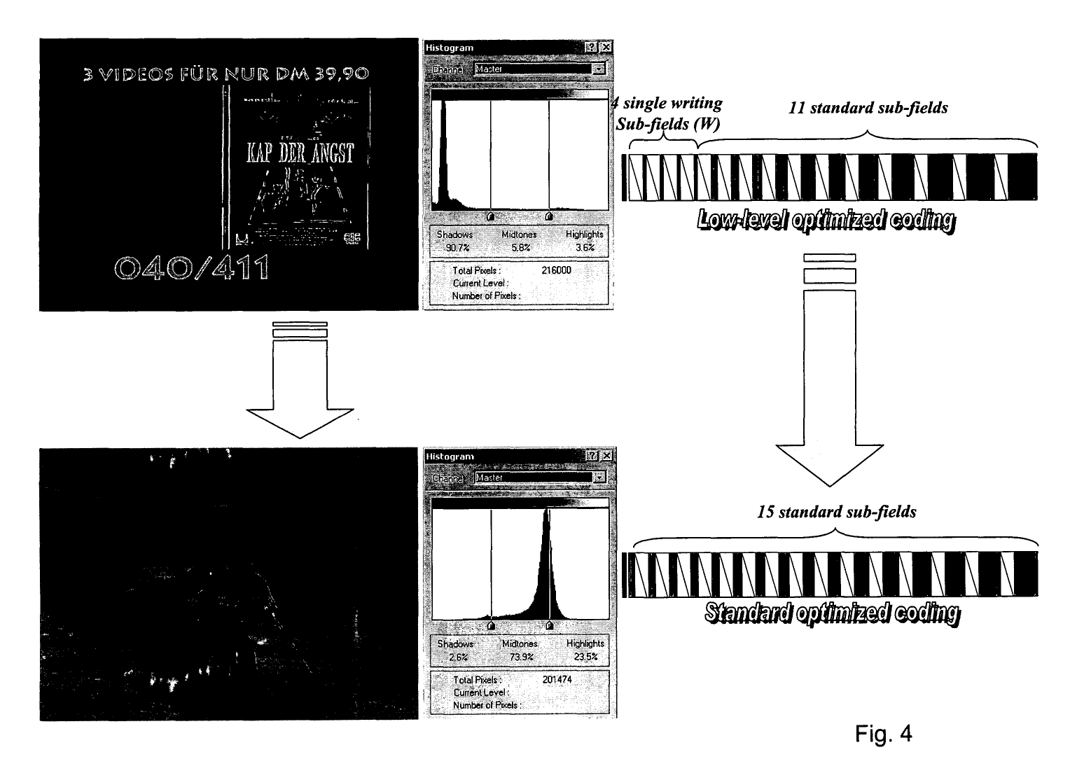

Furthermore, one can see in the previous Tables 1 to 3 that the single-writing operation is mainly useful to render the video levels between 0 and 30/40 (dark area). Therefore, such a concept can be meaningfully improved by the use of a statistical picture analysis. Indeed, if the picture contains many critical levels (0→40) a sub-field system based on one or more single-writing operation is used whereas standard encoding is used for other kinds of pictures. This is illustrated in FIG. 4. At the top of it a very dark picture is shown. Under this picture there is depicted a relatively bright picture. On the right side of each picture a corresponding histogram shows the brightness distribution of the picture. The peak of the distribution of the dark picture lies in the shadows, whereas the peak of the distribution of the bright one lies in the midtones near the highlights. The different codings introduced in connection with FIG. 3 are applicable to these pictures respectively. A sub-sustain weighting including the 4 single writing sub-fields is advantageously applied to the dark picture. In contrast to that the standard optimized coding, wherein each sub-field includes one sustain cycle, is applied to the bright picture. Thus, in none of these pictures quantization steps are visible. This concept can further enhance a Meta-code concept as depicted in the European patent application EP-A-2290907.1.

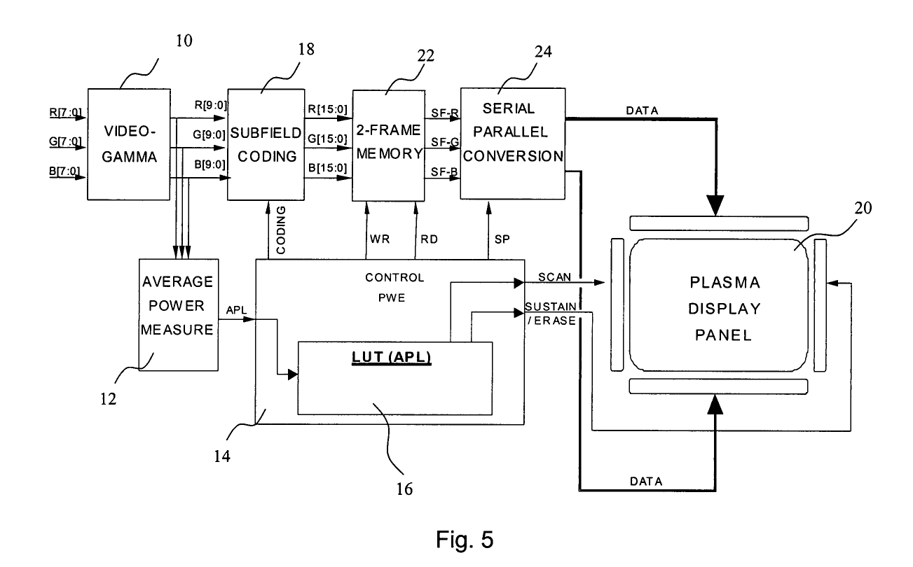

FIG. 5 illustrates a possible circuit implementation of the inventive system. According to this block diagram the input signals R, G, B for each colour are provided in a code length of 8 bits, i.e. bit 7 to bit 0. Such an input RGB picture (3×8 bit) is sent to a video gamma block 10. The output signals of the video gamma block obtained by the gamma function has a resolution of 10 bits per colour. This pre-corrected RGB data is analysed in an average power measure block 12 which gives the computed average power value APL to a PWE control block 14. The average power value of a picture can be calculated by simply summing up the pixel values for all RGB data streams and dividing the result through the number of pixel values multiplied by 3.

The control block 14 includes a look up table LUT 16, so that depending on the APL the corresponding parameters are chosen from this LUT:

the sub-field structure, i.e. how many addressing blocks are used for one frame in total. The corresponding video encoding is transmitted through the information “CODING” towards a sub-field coding block 18.

the signal SCAN for addressing those luminous elements of a plasma display panel 20 which have to be activated for a picture frame.

the signal SUSTAIN/ERASE determining the number of sustain impulses or the erasing impulse for each addressed luminous element. If zero sustain is chosen, a sub-sustain weighting with addressing only will be performed. Thus, the corresponding waveforms for erasing, addressing, sustaining etc. are defined.

Even it is possible to use the same sub-field structure without taking into account the average power level APL the corresponding results would be of lower quality.

The sub-field coding parameters (CODING) define the number of sub-fields, positioning of the sub-fields, the weights of the sub-fields and the types of the sub-fields as explained in WO 00/46782.

The output signals of the video gamma unit 10 are also input to the sub-field coding unit 18, where the sub-field coding process is done. Here, to each normalized pixel value a sub-field code word is assigned. For some values more than one possibility to assign a sub-field coding word can be alternatively available. In a simple embodiment there may be a table for each mode so that the assignment is made with this table. Ambiguities can be avoided in this way.

The PWE control block 14 also controls the writing WR of the RGB pixel data output from the sub-field coding unit 18 into a 2-frame memory 22. Furthermore, the PWE control block 14 controls the reading RD of RGB sub-fields data SF-R, SF-G and SF-B from the 2-frame memory 22 and the serial to parallel conversion circuit 24 via a control line SP. The read bits of the sub-field code words are collected in the serial/parallel conversion unit 24 for a whole line of the PDP 20. As there are e.g. 854 pixel in one line, this means 2562 sub-field coding bits need to be read for each line per sub-field period. These bits are input in the shift registers of the serial/parallel conversion unit 24. The resulting DATA are input to the PDP 20.

Note, that an implementation can be made with two frame memories best. Data is written into one frame memory pixel wise, but read out from the other frame memory sub-field wise. In order to be able to read the complete first sub-field the whole frame must already be present in the memory. This calls for the need of two whole frame memories. While one frame memory is being used for writing, the other is used for reading, avoiding in this way reading the wrong data.

The described implementation introduces a delay of 1 frame between power measurement and action. Power level is measured, and at the end of a given frame, the average power value becomes available to the controller.

What is claimed is:

1. Method for driving a display device having a plurality of luminous elements including the steps of
addressing those luminous elements which have to be activated for one complete frame period or a part of it, called activation cycle or sub-field, by applying an addressing impulse having a predetermined writing voltage to each of them, and
controlling the light output of at least one of said addressed luminous elements on the basis of the energy of said addressing impulse.

2. Method according to claim 1, wherein at least one of said addressed luminous elements is activated in said one frame period by only said addressing impulse.

3. Method according to claim 1, wherein at least one of said addressed luminous elements is activated in said one frame period by said addressing impulse and at least one sustain impulse having a predetermined sustain voltage.

4. Method according to claim 1, wherein the activation energy of the one addressing impulse is smaller than that of one sustain impulse.

5. Method according claim 1, wherein the activation of one of said luminous elements for one frame period is performed by a plurality of activation cycles and an erasing operation is performed at the end of each activation cycle.

6. Method according to claim 5, wherein said addressing operation is performed at the begin of each activation cycle and optionally a sustain operation is performed after the addressing operation.

7. Method according to claim 1, further including the step of performing a picture analysis for a decision of using that addressing impulse for controlling the light output of several of said addressed luminous elements.

8. Method according to claim 7, wherein said addressing impulse is used for controlling the light output in case of essentially white pictures having reduced maximal brightness.

9. Method according to claim 7, wherein said addressing impulse is used for controlling the light output if the brightness of the present frame is lower than a predetermined threshold or the statistical distribution of luminance shows major dark regions.

10. Method according to claim 9, wherein said threshold is lower than 10% of maximum brightness.

11. Apparatus for driving a display device having a plurality of luminous elements with
addressing means for addressing at least one of said luminous elements for one complete frame period or a part of it called activation cycle, by applying an addressing impulse having a predetermined writing voltage to each of said luminous elements, and
controlling means connected to said addressing means for controlling the light output of each of said luminous elements to be addressed by applying at least one sustain impulse having a predetermined sustain voltage,
characterized in that
the light output of at least one of said luminous elements to be addressed is controllable by said controlling means also on the basis of the energy of said addressing impulse from said addressing means.

12. Apparatus according to claim 11, wherein at least one of said luminous elements to be addressed is activatable in said one frame period by only said addressing impulse.

13. Apparatus according to claim 11, wherein at least one of said addressed luminous elements is activatable in said one frame period by said addressing impulse and at least one sustain impulse.

14. Apparatus according to claim 11, wherein the activation energy of said addressing impulse is lower than that of one sustain impulse.

15. Apparatus according to claim 11, wherein the light output of each of said addressed luminous elements is controllable by said controlling means for one frame period by a plurality of activation cycles and an erasing operation at the end of each activation cycle.

16. Apparatus according to claim 15, wherein the light output of each of said addressed luminous elements is controllable by said controlling means by applying an addressing impulse at the beginning of said activation cycle followed by an optional sustain impulse.

17. Apparatus according to claim 11, including analysing means for analysing a picture to be displayed, said analysing means being connected to said controlling means so that the light output is controllable on the basis of the picture analysis.

18. Apparatus according to claim 17, wherein said controlling means includes threshold means so that the light output of each of said luminous elements to be addressed is controllable on the basis of the energy of the corresponding addressing impulse if the brightness of a frame analysed by said analysing means is lower than a predetermined threshold or the statistical distribution of luminance shows major dark regions.
